(19) United States
(12) Patent Application Publication
(10) Pub. No.: US 2026/0356413 A1
(43) Pub. Date: Nov. 12, 2026

(54) WHEELED MOBILE DEVICE

(71) Applicant: WONDERLAND SWITZERLAND AG, Steinhausen (CH)

(72) Inventors: Chinming CHENG, Dongguan, Guangdong (CN); Zhengwen GUO, Dongguan, Guangdong (CN); Xiaolong YI, Dongguan, Guangdong (CN); ErXue WANG, Dongguan, Guangdong (CN)

(73) Assignee: WONDERLAND SWITZERLAND AG, Steinhausen (CH)

(21) Appl. No.: 19/131,456

(22) PCT Filed: Nov. 17, 2023
(86) PCT No.: PCT/EP2023/082235

§ 371 Date: May 20, 2025

(30) Foreign Application Priority Data
Nov. 21, 2022 (CN) 202211456487.5

(51) Int. Cl. B62B 7/04; B60B 33/02

(52) U.S. Cl. CPC B62B 7/04; B60B 33/025; B60B 33/026; B60B 2200/43; B62B 2301/0463

(57) ABSTRACT

The present invention discloses a wheeled mobile device comprising: a frame body; at least one wheel provided below the frame body and rotatable around a directing axis relative to the frame body; and a limiting structure provided between the frame body and the wheel, the limiting structure operably limiting a range of directional rotation of the wheel.

### CROSS-REFERENCE TO RELATED APPLICATIONS

This application is a National Stage application of PCT/EP2023/082235, entitled “WHEELED MOBILE DEVICE” and filed on Nov. 17, 2023, which claims the benefit of Chinese Application No. 202211456487.5, filed on Nov. 21, 2022, both of which are incorporated herein by reference in their entirety.

### TECHNICAL FIELD

The present invention relates to a wheeled mobile device.

### BACKGROUND

A wheeled mobile device such as a baby stroller, pet cart, shopping cart, and hand cart, is a common type of infant carrier. The baby stroller usually includes a frame body, a seat, and wheels. The wheels are installed below the frame to provide the travel function of the baby stroller.

The wheels of a common wheeled mobile device include a pair of front wheels and a pair of rear wheels. At present, there are wheeled mobile devices with drift function on the market, each front and rear wheel of the wheeled mobile device is rotatable in all directions around a substantial vertical axis, allowing the wheeled mobile device to move in any direction. However, a problem with the wheeled mobile device with drift function is that when the wheeled mobile device encounters obstacles or travels on slopes, the rear wheel may directional rotate to a forward direction, resulting in a risk of overturning the wheeled mobile device.

### SUMMARY

The present invention discloses a wheeled mobile device comprising: a frame body; at least one wheel provided below the frame body and rotatable around a directing axis relative to the frame body; and a limiting structure provided between the frame body and the wheel, the limiting structure operably limiting a range of directional rotation of the wheel.

In an embodiment, the limiting structure comprises: a first housing connected to the frame body; a second housing connected to the wheel and capable of rotating around the directing axis relative to the first housing; and the limiting structure is provided to limit a rotation range between the first housing and the second housing.

In an embodiment, the first housing is equipped with a first limiting part, and the second housing is provided with a second limiting part; the first limiting part is operatively engageable to the second limiting part to limit the rotation range between the first housing and the second housing.

In an embodiment, the wheel is at least one rear wheel, and the limiting structure prevents the rear wheel from rotating to a forward position.

In an embodiment, one of the first limiting part and the second limiting part is a pin movable close to or away from the other one of the first limiting part and the second limiting part; the other one of the first limiting part and the second limiting part is a groove extending around the directing axis; the first limiting part is operatively movable and insertable into the second limiting part to limit the rotation range between the first housing and the second housing according to an extension range of the second limiting part.

In an embodiment, the pin moves in a direction substantial parallel to the directing axis.

In an embodiment, the second limiting part is provided in the other one of the first housing and the second housing, and at an interface where the first housing and the second housing adjacent to each other.

In an embodiment, the second limiting part is further provided with a locking hole, the first limiting part is insertable into the locking hole to prevent the relative rotation between the first housing and the second housing.

In an embodiment, the locking hole is provided at a middle of a circumferential direction of the second limiting part.

In an embodiment, the groove has acr-shaped with an extension range of 300°.

In an embodiment, the first limiting part is connected to an unlocking structure through a connecting member, and the unlocking structure is operable to move the first limiting part away from the second limiting part through the connecting member.

In an embodiment, the unlocking structure comprises: a driving member connected to a first end of the connecting member and rotatable to pull the connecting member; an operating member operable to move from an outside of the wheeled mobile device; and a moving member engaged to the operating member, the driving member is driven by the moving member according to the movement of the operating member.

In an embodiment, a second end of the connecting member is connected to the first limiting part, and the first limiting part is disengaged from the second limiting part by the connecting member according to the pulling of the connecting member.

In an embodiment, the operating member is provided at a handlebar of the wheeled mobile device and is movable perpendicular to the handlebar; the operating member is protruded towards an interior of the handlebar to form an abutment which abuts the moving member; the moving member is formed with a guiding part on a side facing the driving member, and a protrusion part rising along a rotation axis of the driving member is provided on a periphery of the driving member, the guiding part abuts the protrusion part causing the movement of the operating member to drive the moving member, and the guiding part then abuts the protrusion part to rotate the driving member.

In an embodiment, the unlocking structure includes two driving members, one of the driving members drives the limiting structure through the connecting member, and the other one of the driving members drives a unblock module through the other connecting member; the unlocking structure comprises two moving members corresponding to the two driving members and capable of driving the corresponding driving member, respectively; the operating member is provided to selectively abut one of the two moving members.

In an embodiment, the unlocking structure further includes a selecting member operable to form a linkage between one of the two moving members and the operating member, such that the moving member in linkage with the operating member is pushable by the operating member, thereby driving the corresponding driving member.

In an embodiment, the limiting structure is connected to the wheel through a wheel seat movable longitudinally relative to the limiting structure, and a buffer spring is provided with between the limiting structure and the wheel seat.

In an embodiment, the wheeled mobile device is a baby stroller or a pet cart.

The present invention further discloses a wheeled mobile device comprising: a frame body; two wheels provided below the frame body and rotatable around a directing axis relative to the frame body; and a limiting structure provided between the two wheels that limits a range of directional rotation of the wheels.

In an embodiment, the limiting structure comprises: two first housings connected to the frame body, respectively; two second housings connected to the two wheels and rotatable around the directing axis relative to the two first housings, respectively; and a linkage member connected to the two second housings, such that the two second housings rotate synchronously around their respective directional axes.

In an embodiment, the linkage member is a rod that extends transversely and connected to each second housing through a respective linkage shaft parallel to the directing axis; and the linkage member interferes with the first housing to limit the rotational range of the second housings.

### BRIEF DESCRIPTION OF THE DRAWINGS

FIG. 1 is a side view of the wheeled mobile device according to the first embodiment of the present invention, wherein the rear wheels are in a rearward position;

FIG. 2 is a side view of the wheeled mobile device, wherein the rear wheels are in a forward position;

FIG. 3 is a perspective view of the wheeled mobile device, wherein the rear wheels are in a rearward position;

FIG. 4 is a perspective view of the wheeled mobile device, wherein the rear wheels are in an oblique position;

FIG. 5 is a perspective view of the limiting structure and the wheel of the wheeled mobile device;

FIG. 6 is a exploded perspective view of the limiting structure and the wheel;

FIG. 7 is a side sectional view of the limiting structure, wherein the pin is in a released position;

FIG. 8 is a side sectional view of the limiting structure, wherein the pin is in a locked position;

FIG. 9 is a perspective view of the second housing of the limiting structure;

FIG. 10 is a rear view of the wheeled mobile device, in which a part of the controller housing is removed to show the interior of the unlocking structure;

FIG. 11 is an enlarged view of the block part of FIG. 10;

FIG. 12 is a partial enlarged view of the unlocking structure of the wheeled mobile device, in which the unlocking structure housing and the mounting plate are removed;

FIG. 13 is an enlarged exploded view of the unlocking structure;

FIG. 14 is a perspective view of a wheeled mobile device according to the second embodiment of the present invention, wherein the wheels are in the rearward position;

FIG. 15 is an enlarged view of the block part of FIG. 14;

FIG. 16 is a perspective view of the wheeled mobile device, wherein the wheels are in the oblique position;

FIG. 17 is a perspective view of the wheeled mobile device according to the third embodiment of the present invention;

FIG. 18 is a perspective view of the second housing of the wheeled mobile device.

List of reference marks:

```
1 Wheeled Mobile Device
  100 Limiting Structure
    110 First Housing
      111 Accommodating Groove
      112 First Segment
      113 Second Segment
    120 Second Housing
      121 Second Limiting Part
      122 Directing Shaft Hole
      123 Locking Hole
      124 Disc-Shaped Part
      125 Wheel Seat Connection Part
      128 Connection Seat
    130 Directing Shaft
    140 First Limiting Part
    150 Restoration member
  200 Unlocking Structure
    210 Driving Member
      211 Protrusion Part
      212 Recess Part
      C Rotation Axis
    220 Moving Member
      221 Guiding Part
      222 Insertion Part
      223 Pressing Surface
    230 Operating Member
      231 Abutment
      232 Head
    240 Unlocking Structure Housing
    250 Mounting Plate
    260 Spring
    270 Selecting member
      271 Button
      272 Sliding Part
      273 Restoration member
    290 Connecting Member
      291 First End
      292 Second End
  300 Wheel
    310 Wheel Seat
    320 Buffer Spring
  400 Frame Body
    410 Handlebar
  500 Limiting Structure
    510 Linkage Member
    520 Linkage Shaft
  A Directing Axis
```

### DETAILED DESCRIPTION

Although the present invention is explained and described with reference to specific embodiments herein, it should not be limited to the details shown. Specifically, within the scope of the equivalent solutions of the claims and without departing from the present invention, various modifications can be made to these details.

The descriptions of “front”, “back”, “up”, “down” and other directions mentioned herein are only for the convenience of understanding. The present invention is not limited to these directions, but can be adjusted according to actual situations. Although the present invention has been described in typical embodiments, the terms used are illustrative and exemplary, rather than restrictive.

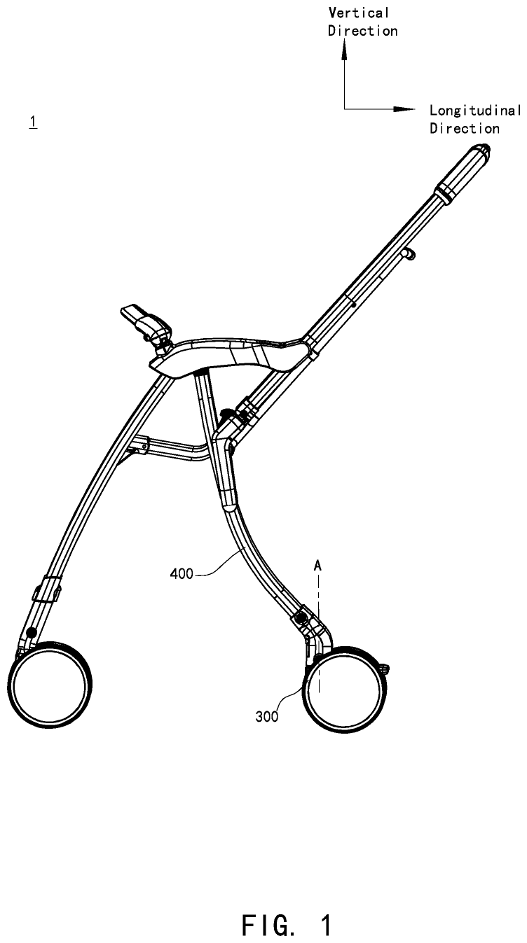

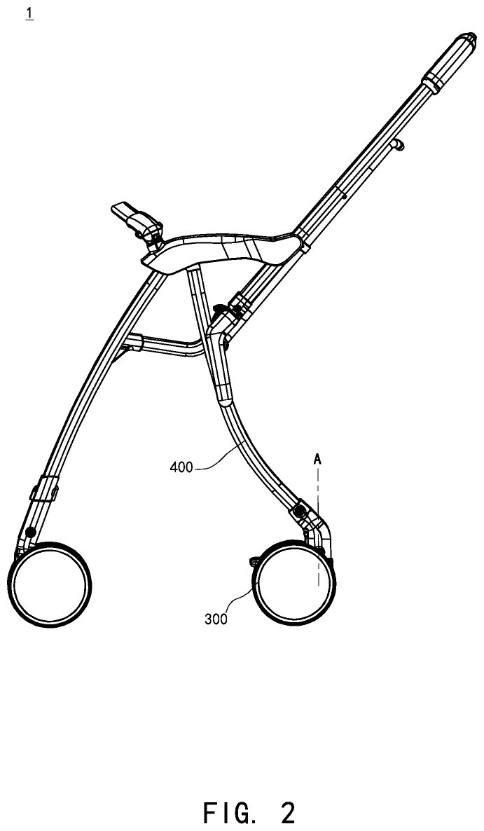

Referring to FIGS. 1 to 2, a first embodiment of the wheeled mobile device 1 according to the present invention is generally described. In this embodiment, the wheeled mobile device 1 is illustrated as a baby stroller for example. However, it should be understood that the wheeled mobile device 1 of the present invention can also be a pet cart, shopping cart, handcart, etc.

The wheeled mobile device 1 includes a frame body 400 and at least one wheel 300 provided below the frame body 400. The wheel 300 is rotatable around a directing axis A relative to the frame body 400. More specifically, the wheel 300 is rotatable between a rearward position as shown in FIG. 1 and a forward position as shown in FIG. 2 around the substantial vertically extended directing axis A.

The wheels 300 of the wheeled mobile device 1 of this embodiment include a pair of front wheels and a pair of rear wheels, each of the wheels 300 can be provided to rotate around its respective directing axis A (i.e., a full directional rotation). In this way, the wheeled mobile device 1 can travel in any direction (i.e. a drift travel).

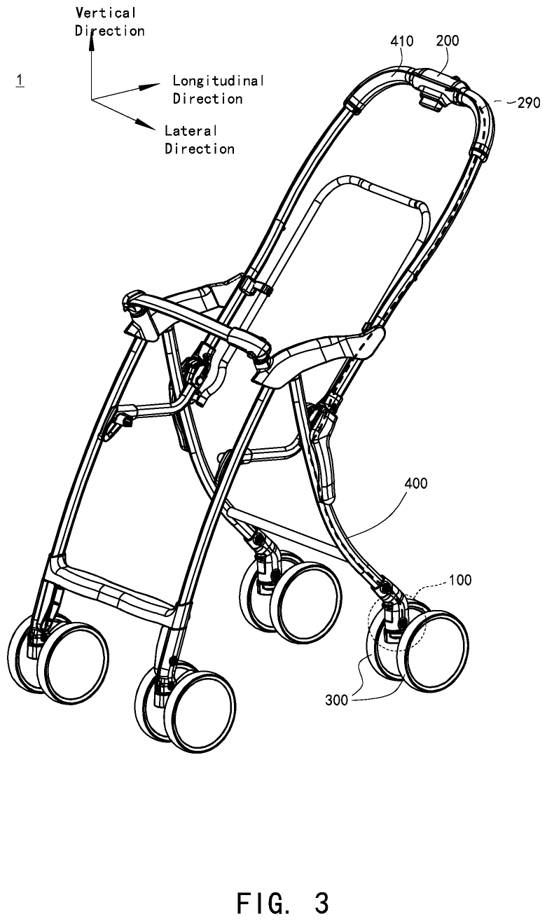

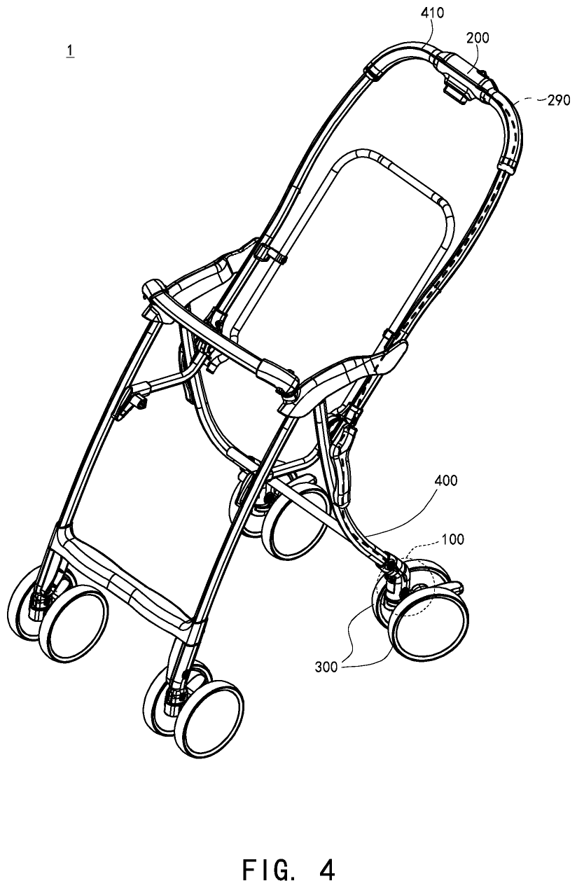

Referring to FIGS. 3 and 4 in which the limiting structure 100 is shown. The limiting structure 100 is provided between the frame body 400 and the wheel 300, and the limiting structure 100 is operable to limit a range of directional rotation of the wheel 300. The figures only shows the limiting structure 100 provided at one rear wheel, however, it should be understood that the limiting structure 100 can be provided at any wheel 300.

FIG. 3 shows the wheel 300 in the rearward position, and FIG. 4 shows the wheel 300 in an oblique position. In this embodiment, the wheel 300 is limited to rotating within a certain angle range based on the rearward position, that is, it is prevented from rotating to the forward position. However, it should be understood that in other embodiments, the wheel 300 can be limited to rotate within other angle ranges, such as within a certain angle range based on forward position, lateral position, or oblique position. Moreover, the angle range can be set according to the requirements, as detailed below.

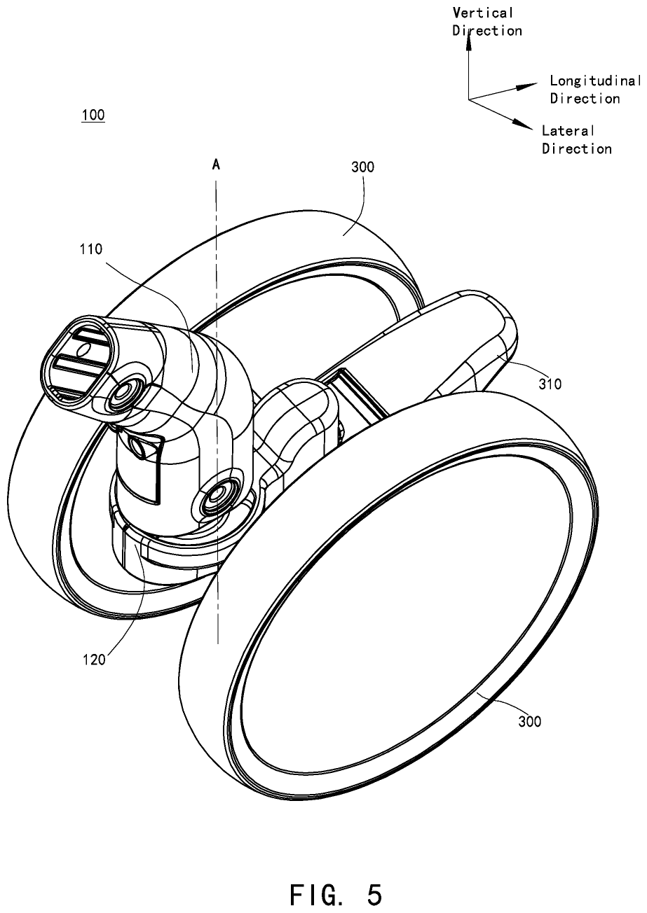

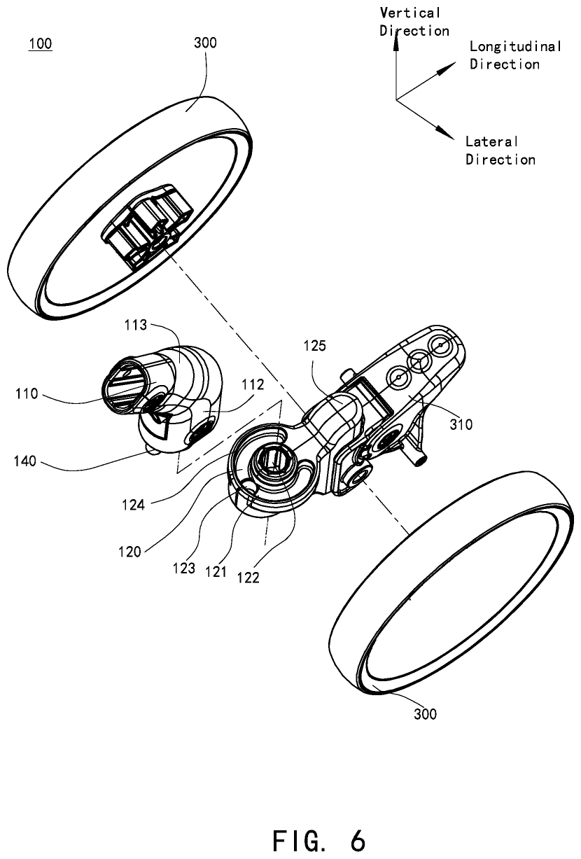

Referring to FIGS. 5 and 6, the limiting structure 100 according to the present invention is described in detail.

The limiting structure 100 includes a first housing 110 and a second housing 120. The second housing 120 is connected to the wheel 300 and rotatable around the directing axis A relative to the first housing 110. The rotational connection between the first housing 110 and the second housing 120 will be described in detail below.

Referring to FIG. 6, the limiting structure 100 is described in more detail, wherein the specific structures of the first housing 110 and the second housing 120, as well as the first limiting part 140 and the second limiting part 121 provided on the first housing 110 and the second housing 120 are shown. In this embodiment, the first housing 110 includes a hollow first segment 112 and a second segment 113 connected vertically. The first segment 112 is provided above the second housing 120, and the first limiting part 140 is provided in the first segment 112. The first segment 112 substantial extends vertically, while the second segment 113 tilts upwards relative to the vertical direction. The second housing 120 includes a disc-shaped part 124 and a wheel seat connecting part 125 connected to each other longitudinally.

The axial direction of the disc-shaped part 124 is provided vertically, and the wheel seat connecting part 125 extends longitudinally. The second limiting part 121 is provided on the disc-shaped part 124, for example, as a groove formed by concave downwards on the vertical upper surface of the disc-shaped part 124 and near the periphery of the disc-shaped part 124. The wheel seat connection part 125 is vertically connected to the wheel 300 through the wheel seat 310. In other embodiments, according to the structure of the wheeled mobile device 1, the first segment 112 and the second segment 113 may also extend in other directions, or the first housing 110 may only include one segment. The second housing 120 may has another appropriate shape, as long as it is connected to the wheel 300.

The first limiting part 140 is operatively engaged to the second limiting part 121 to limit the relative rotation range between the first housing 110 and the second housing 120.

More specifically, in this embodiment, the first limiting part 140 is a pin that movable substantial parallel to the directing axis A, and the second limiting part 121 is a groove that extends in an arc around the directing axis A. The first limiting part 140 is operatively moved and inserted into the second limiting part 121 to limit the relative rotation range between the first housing 110 and the second housing 120 based on the extension range of the second limiting part 121.

In other embodiments, the first limiting part 140 may move at an angle relative to the directing axis A, that is, obliquely engage with the second limiting part 121.

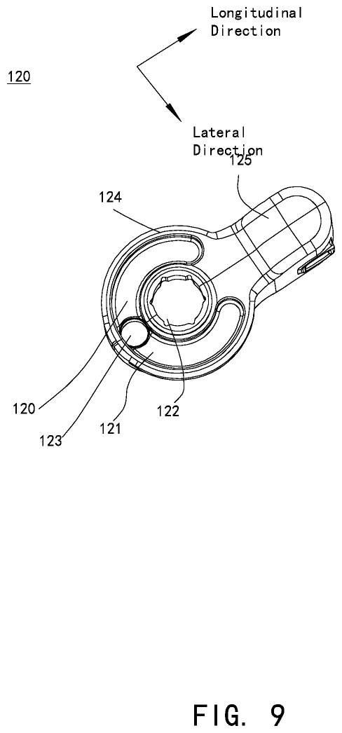

Referring to FIG. 6 in combine with FIG. 9, in this embodiment, a locking hole 123 is also provided in the second limiting part 121 (groove), and the first limiting part 140 (pin) can be inserted into the locking hole 123 to lock the relative rotation between the first housing 110 and the second housing 120. More specifically, the locking hole 123 is open in the middle of the circumferential direction of the second limiting part 121. In this way, when the first limiting part 140 is inserted into the locking hole 123, the wheel 300 is locked in the rearward position.

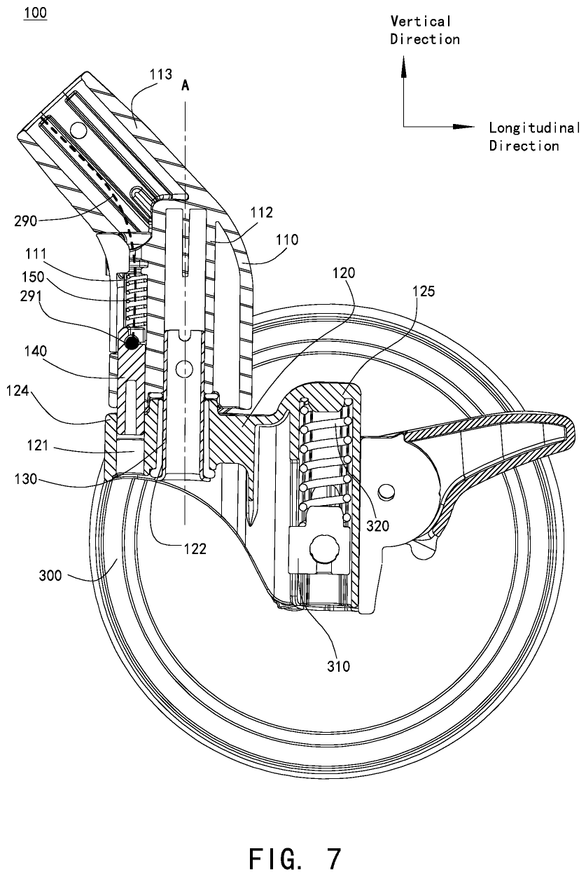

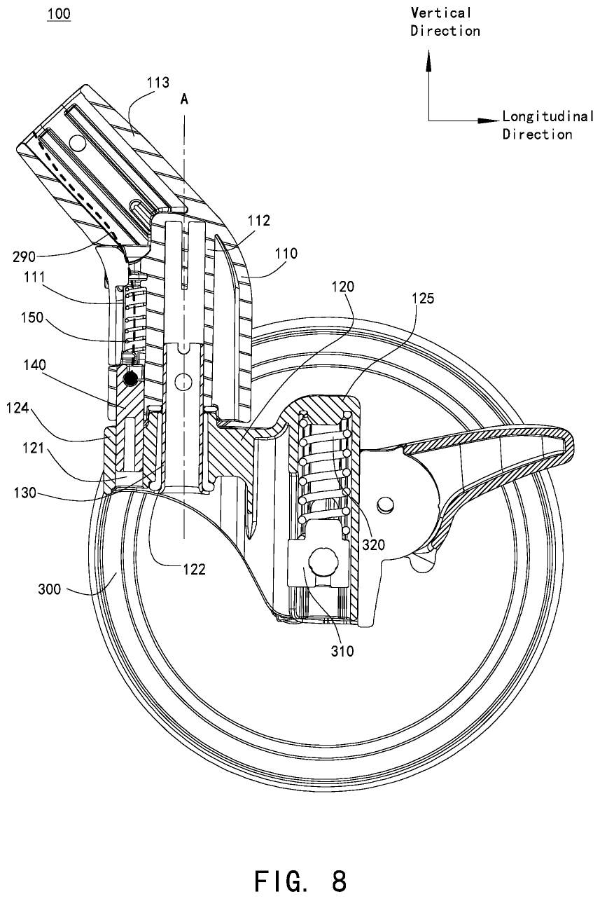

Referring to FIGS. 7 and 8, the specific structure of the limiting structure 100 is further described. The first limiting part 140 (pin) of the limiting structure 100 is in the released position in FIG. 7 and in the locked position in FIG. 8. The second housing 120 is provided with a directing shaft hole 122 at the directing axis A (i.e. along the directing axis A). The directing shaft 130 is inserted into the directing shaft hole 122 and connected to the first housing 110 to allow the second housing 120 to rotate relative to the first housing 110. In this way, through the relative rotation between the first housing 110 and the second housing 120, the wheel 300 is rotatable around the directing axis A relative to the frame body 400.

In this embodiment, an accommodating groove 111 is formed in the first housing 110, and the first limiting part 140 is provided in the accommodating groove 111 and can slide along the accommodating groove 111. The restoration member 150 is provided in the accommodating groove 111 and pushes the first limiting part 140 towards the second limiting part 121, that is, the pin is pressed and inserted into the groove. When the first limiting part 140 is engaged to the second limiting part 121, the first limiting part 140 extends more from the accommodating groove 111. When the first limiting part 140 is disengaged from the second limiting part 121, the first limiting part 140 extends less from the accommodating groove 111.

The second limiting part 121 (groove) is open on the second housing 120 and is located at an interface between the first housing 110 and the second housing 120 adjacent to each other. In this way, the first limiting part 140 (pin) can be engaged into the second limiting part 121. The first limiting part 140 is movable to the second limiting part 121 under the action of gravity and/or the pushing force of the restoration member 150.

FIGS. 7 and 8 further illustrate the wheel seat 310. The wheel seat connection part 125 of the second housing 120 of the limiting structure 100 is connected to the wheel 300 through the wheel seat 310, the wheel seat 310 movable longitudinally relative to the limiting structure 100, and a buffer spring 320 is provided between the wheel seat connection part 125 and the wheel seat 310. More specifically, the wheel seat 310 is provided below the second housing 120. The longitudinal end of the second housing 120 is rotatably connected to the first housing 110, and the other longitudinal end of the second housing 120 is connected to the wheel seat 310. The buffer spring 320 is substantial vertically provided between the second housing 120 and the wheel seat 310, and the wheel 300 is rotationally connected to the wheel seat 310. In this way, the buffer spring 320 can alleviate the vertical impact and turbulence suffered by the wheeled mobile device 1, thereby providing a comfortable experience for riders.

In other embodiments, the wheel seat 310 may be omitted and the wheel 300 may be directly connected to the limiting structure 100, as will be detailed later.

Referring to FIGS. 7 and 8 in combination with FIG. 3, the first housing 110 is connected to the frame body 400, specifically the second segment 113 of the first housing 110 is connected to the frame body 400. The first limiting part 140 is connected to the unlocking structure 200 through the connecting member 290, and the unlocking structure 200 is operable to move the first limiting part 140 away from the second limiting part 121 through the connecting member 290. More specifically, the second end 291 of the connecting member 290 is connected to the edge of the first limiting part 140. For example, the connecting member 290 can be a flexible wire, and the second end 291 can be a hammer head which is connected to the corresponding recess part of the first limiting part 140.

In FIG. 8, the first limiting part 140 is inserted into the second limiting part 121. In FIG. 7, the first limiting part 140 is pulled by the connecting member 290 and partially disengaged from the second limiting part 121. When the first limiting part 140 completely disengaged from the second limiting part 121, the wheel 300 is rotatable at a certain angle corresponding to the second limiting part 121.

As mentioned above, the second limiting part 121 can be provided as a groove formed by concaving downwards on the vertical upper surface of the disc-shaped part 124 and near the periphery of the disc-shaped part 124. The second limiting part 121 can extend circumferentially from the edge of the locking hole 123 towards both sides. In this embodiment, the extension range of the second limiting part 121 is approximately 300°. The second limiting part 121 is provided based on the rearward position of the wheel 300, that is, when the wheel 300 is in the rearward position, the first limiting part 140 is substantial located in the middle of the second limiting part 121. It should be understood that by changing the angle position and angle range of the second limiting part 121, the wheel is rotatable within a selected angle range based on the forward position, lateral position, or oblique position.

The first limiting part 140 and the second limiting part 121 are described above as the pin and the groove for example. However, it should be understood that the first limiting part 140 and the second limiting part 121 can be provided in another form. For example, the first limiting part 140 may be a limiting block, while the second limiting part 121 may be a wall parallel to the directing axis A.

In addition, in other embodiments, the first limiting part 140 and the second limiting part 121 can be interchanged with each other, that is, the first limiting part 140 can be a groove (such as an arc-shaped groove), and the second limiting part 121 can be a pin. In this way, the accommodating groove 111 is correspondingly open in the first housing 110.

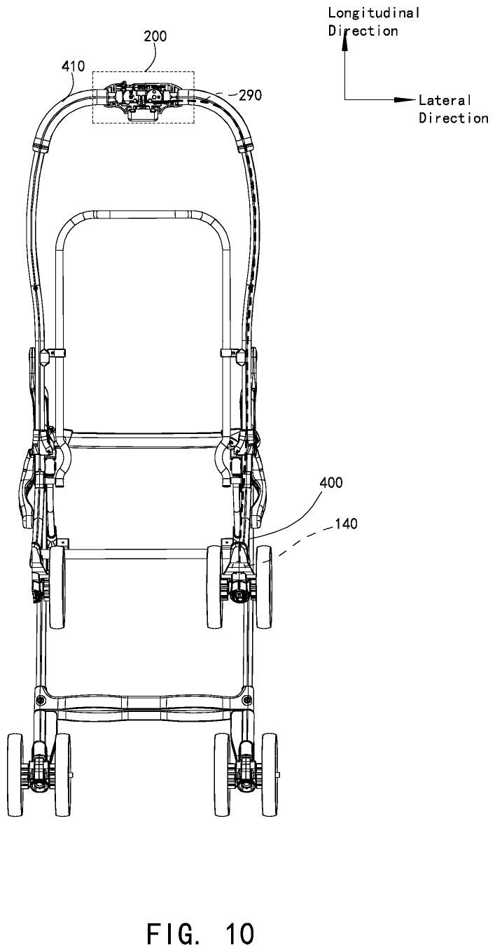

Referring to FIGS. 10 to 13, the unlocking structure 200 is described in detail.

As shown in FIG. 10, the connecting member 290 is connected to the unlocking structure 200, and the unlocking structure 200 is operable to pull the first limiting part 140 through the connecting member 290.

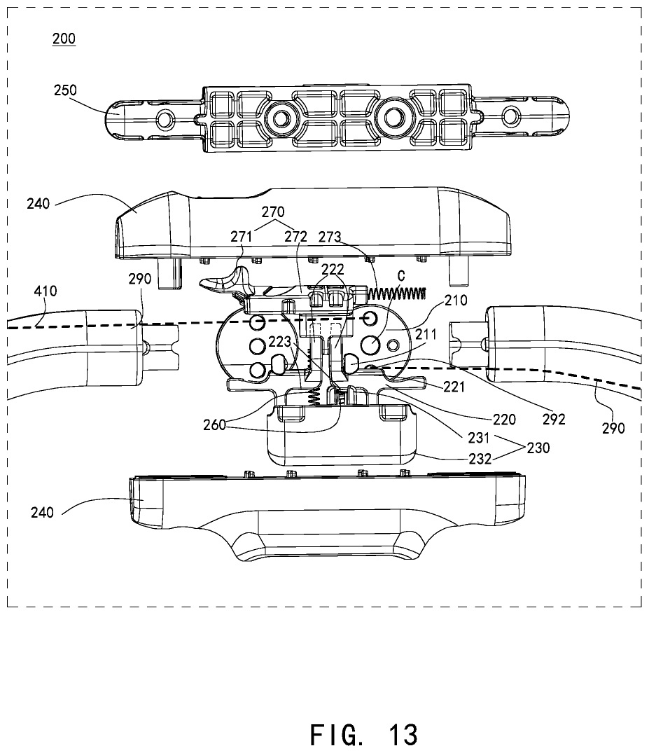

As shown in FIG. 13, the unlocking structure 200 includes an unlocking structure housing 240, a mounting plate 250, at least one driving member 210, an operating member 230, a moving member 220, and a spring 260. The unlocking structure housing 240 is transversely provided at the handlebar 410 of the wheeled mobile device 1, and at least partially accommodates other components of the unlocking structure 200. In this embodiment, the unlocking structure housing 240 is formed by merging two half housings for easy installation. However, in other embodiments, the unlocking structure housing 240 can be an integral component. Alternatively, the unlocking structure housing 240 can be omitted and other components of the unlocking structure 200 can be directly installed in the hollow handlebar 410.

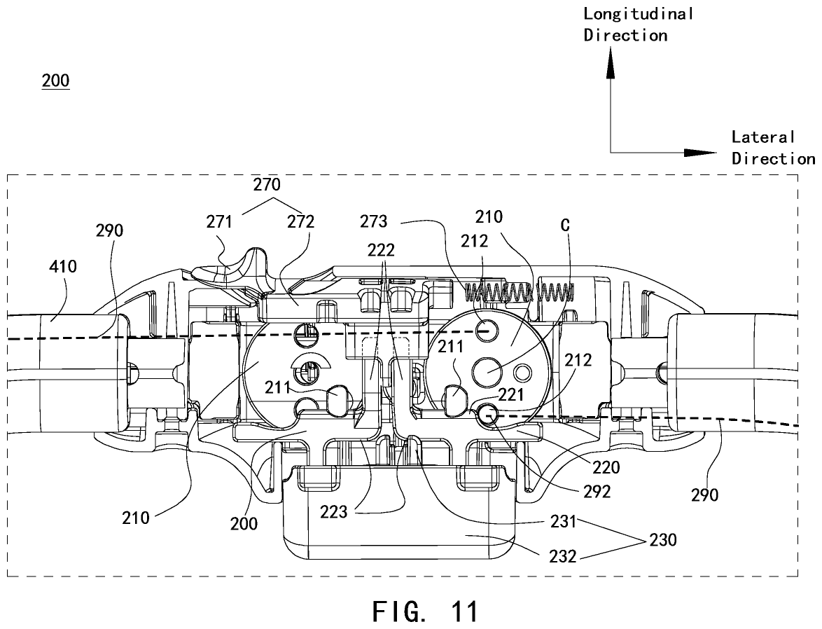

Referring to FIGS. 11 to 13 at the same time, the mounting plate 250 is transversely provided in the unlocking structure housing 240. The driving member 210 can be rotatably connected to the mounting plate 250 around the rotation axis C (perpendicular to the drawing surface and at the center of the driving member 210). The driving member 210 is connected to the first end 292 of the connecting member 290 and is rotatable to pull the connecting member 290. More specifically, the first end 292 of the connecting member 290 (such as in the form of a hammer head) is connected to a recess part 212 open at the periphery of the driving member 210. When the driving member 210 rotates clockwise around the rotation axis C (in the observe direction in FIGS. 11 to 13), the connecting member 290 is pulled. In one embodiment, the driving member 210 may be provided with multiple recess parts 212 for connection to multiple connecting members 290. For example, the driving member 210 can be provided with one recess part 212 on the side near the operating member 230 and one recess part 212 on the side away from the operating member 230. Two connecting members 290 are respectively connected to these two one recess parts 212, such that when the driving member 210 rotates clockwise around the rotation axis C, the two connecting members 290 are respectively pulled. One of the connecting members 290 can be connected to the limiting structure 100 of the present invention (FIG. 4), and the other connecting member 290 can be connected to another limiting structure (not shown) or other unlocking modules, such as handlebar reversing locking modules, frame body folding locking modules, etc. Therefore, it is possible to control multiple unlocking modules simultaneously through one driving member 210.

The operating member 230 is operable and movable from the outside of the wheeled mobile device 1. The moving member 220 is engaged to the operating member 230 and can drive the rotation of the driving member 210 according to the movement of the operating member 230.

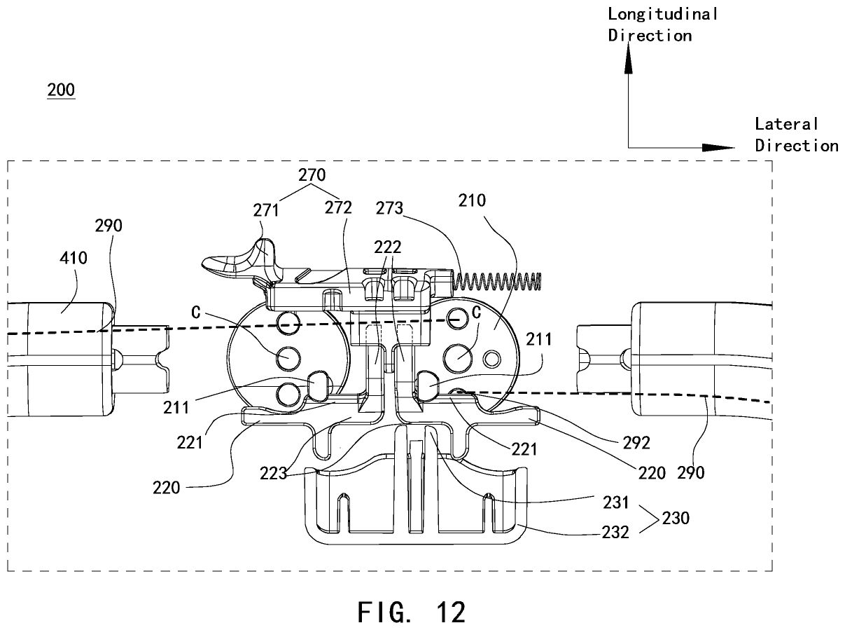

More specifically, the operating member 230 is provided at the handlebar 410 of the wheeled mobile device 1 and movable perpendicularly (such as longitudinally) with the handlebar 410. The operating member 230 protrudes towards the interior of the handlebar 410 and forms an abutment 231 which abuts the moving member 220. The moving member 220 is formed with a guiding part 221 on one side facing the driving member 210. The periphery of the driving member 210 is provided with a protrusion part 211 that rises along the rotation axis C of the driving member 210. The guiding part 221 can abut the protrusion part 211 to cause the rotation of the driving member 210. More specifically, as shown in FIG. 12, the operating member 230 includes a substantial rectangular head 232, and the abutment 231 is connected to the head 232 and extends from the head 232 towards the interior of the handlebar 410.

In this embodiment, the guiding part 221 is a transversely extending abut surface. The position of the protrusion part 211 is provided such that when the driving member 210 is pushed and pressed by the moving member 220, the connecting member 290 is pulled. For example, for the driving member 210 on the right side in FIGS. 11 to 13, the protrusion part 211 is provided on the left side of the rotation axis C. When the guiding part 221 pushes and presses the protrusion part 211, the driving member 210 rotates clockwise, thereby pulling the connecting member 290.

In one embodiment, the unlocking structure 200 includes two driving members 210 provided transversely, each used to drive the corresponding unlocking module. For example, one driving member 210 serves to drive the wheel rotation locking module, which is the limiting structure 100 described herein, while the other driving member 210 serves to drive the handlebar reversing locking module, the frame body folding locking module, etc. The unlocking structure 200 includes two moving members 220, each corresponding to a driving member 210.

The operating member 230 can abut and push one of the two moving members 220.

Furthermore, the unlocking structure 200 includes a selecting member 270, which is at least partially provided in the unlocking structure housing 240 and is operable to form a linkage state between one of the two moving members 220 and the operating member 230. The linkage state refers to the moving member 220 being driven by the operating member 230, for example, one moving member 220 forms an abutment relationship with the operating member 230, such that the moving member 220 can be pushed by the operating member 230, thereby driving the driving part 210 corresponding to the moving member 220. More specifically, the selecting member 270 is movable in the unlocking structure housing 240 and movable transversely (left and right) relative to the unlocking structure housing 240. The two moving members 220 each have a longitudinally extended insertion part 222 which is longitudinally inserted into the selecting member 270, for example, inserted into two longitudinal grooves of the sliding part 272 of the selecting member 270 (not shown) respectively, allowing each moving member 220 to slide longitudinally relative to the selecting member 270 and move transversely in the unlocking structure housing 240 with the selecting member 270.

The unlocking structure housing 240 is further provided with a restoration member 273, which abuts between the inner wall of the unlocking structure housing 240 and one end of the selecting member 270. In this embodiment, the restoration member 273 is provided to bias the selecting member 270 transversely to the left position, and in other embodiments, the selecting member 270 can also be biased to the right position.

When the selecting member 270 is located on the left side (as shown in FIGS. 11 to 13), the moving member 220 on the right side forms an linkage relationship with the operating member 230. More specifically, the moving member 220 on the right side has a pressing surface 223 that faces the operating member 230 and extends transversely, the pressing surface 223 can abut the abutment 231 of the operating member 230. In this way, when the selecting member 270 is located on the left side and the user presses on the operating member 230, due to the abutment between the pressing surface 223 and the abutment 231, the moving member 220 on the right side correspondingly moves upwards, and then the protruding part 211 of the driving member 210 moves along the guiding part 221, causing the driving member 210 on the right side to rotate clockwise, resulting in the connecting member 290 being pulled.

When the selecting member 270 is located on the right side (not shown), both moving members 220 move to the right with the selecting member 270, thus forming an linkage relationship between the moving component 220 on the left side and the operating member 230. In this way, when the selecting member 270 is located on the right side and the user presses on the operating member 230, due to the abutment between the pressing surface 223 and the abutment 231, the moving member 220 on the left side correspondingly moves upwards, and then the protrusion part 211 of the driving member 210 moves along the guiding part 221, causing the driving member 210 on the left side to rotate counterclockwise, thus the connecting member 290 is pulled.

It should be understood that the longitudinal, transverse, left, right and other directional names mentioned in the description of the unlocking structure 200 above are for ease of understanding and are specific to the situation where the unlocking structure 200 is provided on the transversal and horizontal section of the handlebar 410. In other embodiments, the unlocking structure 200 may also be provided on other parts, such as in the vertical or curved section of the handlebar 410, and the above-mentioned orientation of the unlocking structure 200 may be correspondingly changed.

In benefit of the unlocking structure 200 of the present invention, the user may move the selecting member 270 by one finger (such as a thumb) on one side while holding the handlebar 410, and using another finger (such as the other four fingers) on the other side to push the operating member 230. Therefore, multiple locking modules, including the limiting structure 100, is operable with just one hand.

It should be understood that in other embodiments, the unlocking structure 200 can also be provided in other appropriate forms, such as a toggle lever, cam, or electric actuator, as long as the connecting member 290 can be pulled according to the user's operation.

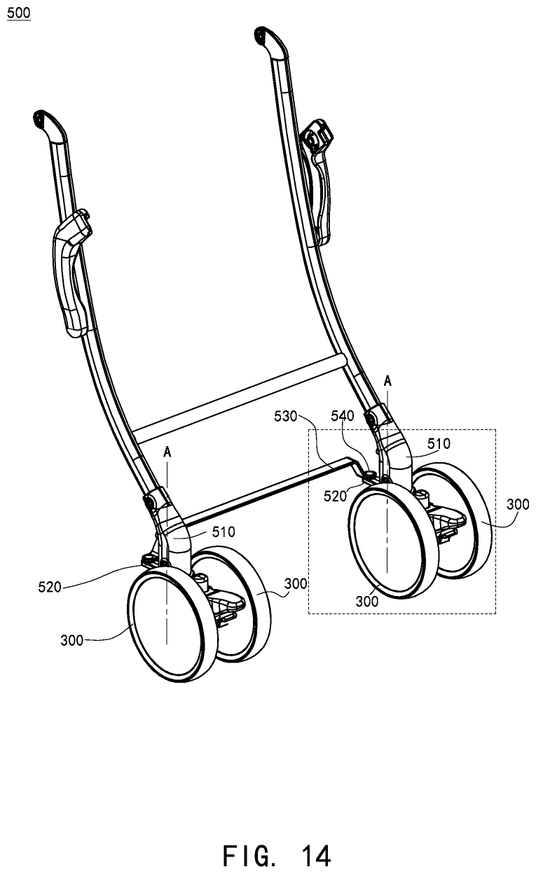

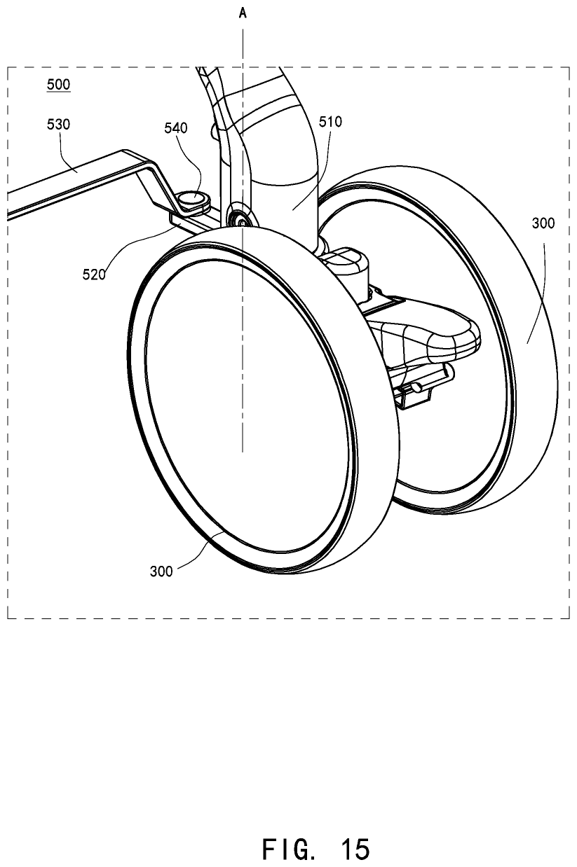

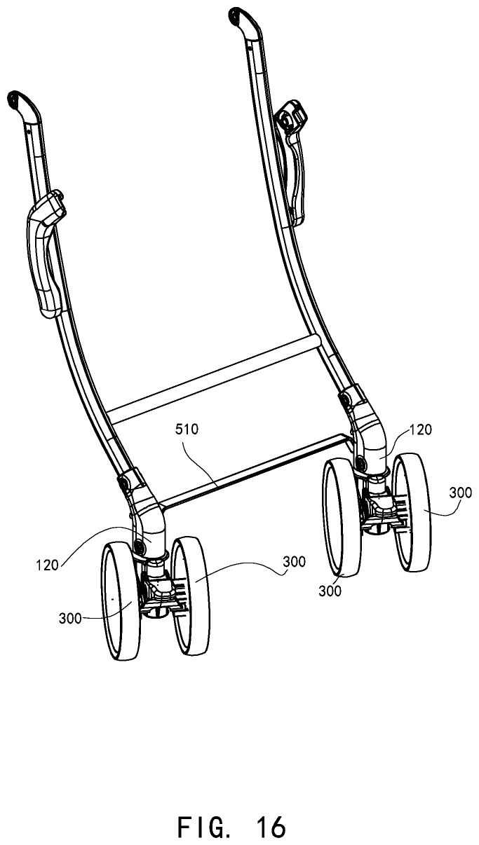

Referring to FIGS. 14 to 16, the limiting structure 500 according to the second embodiment of the present invention is described. The limiting structure 200 of the first embodiment and the limiting structure 500 of the second embodiment can be applied separately or jointly to the wheeled mobile device.

In the second embodiment, the wheeled mobile device 1 is provided with a pair of wheels 300 (such as the rear wheel), and the limiting structure 500 is provided between the two wheels 300. The limiting structure 500 includes a first housing 510, a second housing 520, a linkage member 530, and a linkage shaft 540. The first housing 510 and the second housing 520 can be similar to the first housing 110 and the second housing 120 of the first embodiment. The linkage member 530 is connected between two second housings 520, allowing the two second housings 520 to rotate synchronously around their respective directional axes A. The linkage member 530 limits the rotation range of the wheel 300. When the wheel 300 rotates excessively (such as tending to rotate to the forward position), the linkage member 510 will interfere with the corresponding second housing 520, thereby preventing the further rotation of the wheel 300.

In one embodiment, the linkage member 530 is a rod extending transversely and connected to each second housing 520 through the linkage shaft 540 parallel to the directing axis A. In other embodiments, the linkage member 510 may also be in other appropriate forms, such as in the form of a wire.

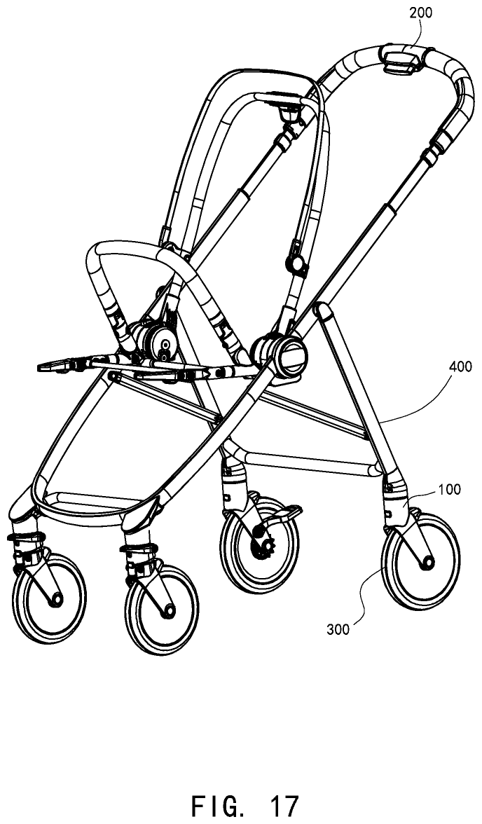

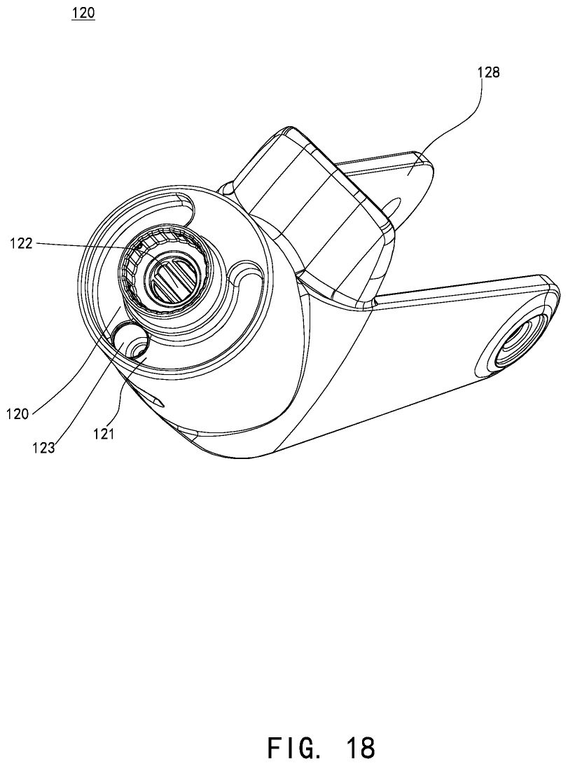

Referring to FIGS. 17 to 18, a third embodiment of the present invention is described.

In the third embodiment, the limiting structure 100 is directly connected to the wheel 300, thus omitting the wheel seat 310. As shown in FIG. 18, the second housing 120 in the limiting structure 100 includes a connection seat 128 extending diagonally, the connection seat 128 is connected to the wheel shaft of the wheel 300 (not shown), thereby rotatably connected to the wheel 300. In this embodiment, the connection seat 128 is a forked portion extending to both sides of the wheel 300. In other embodiments, the connection seat 128 can be in any appropriate form as long as the wheel 300 can be rotatably connected to the second housing 120.

It should be understood that although the first embodiment illustrates a dual wheel structure (each limiting structure 100 connected to two wheels 300) and the third embodiment illustrates a single wheel structure (each limiting structure 100 connected to two wheels 300), both the first and third embodiments can be applied to the dual wheel structure or the single wheel structure.

In summary, a wheeled mobile device with a limiting structure is provided in the present invention, which can limit the rotation range of the wheel according to the user's operation, thereby avoiding the risk caused by the free rotation of the wheel.

Due to the fact that the present invention can be implemented in multiple forms without departing from the spirit and essence of the present invention, it should be understood that the above embodiments are not limited to any of the aforementioned details, but should be interpreted in the broadest scope within the scope of the claims. Therefore, all changes falling within the scope of the claims or their equivalents should be covered by the claims.

1. A wheeled mobile device, characterized in that the wheeled mobile device comprises:
a frame body;
at least one wheel provided below the frame body and rotatable around a directing axis relative to the frame body; and
a limiting structure provided between the frame body and the wheel, the limiting structure operably limiting a range of directional rotation of the wheel.

2. The wheeled mobile device according to claim 1, wherein the limiting structure comprises:
a first housing connected to the frame body;
a second housing connected to the wheel and capable of rotating around the directing axis relative to the first housing; and
wherein the limiting structure is provided to limit a rotation range between the first housing and the second housing.

3. The wheeled mobile device according to claim 2, wherein:
the first housing is provided with a first limiting part, and the second housing is provided with a second limiting part;
the first limiting part is operatively engageable to the second limiting part to limit the rotation range between the first housing and the second housing.

4. The wheeled mobile device according to claim 1, wherein:
the wheel is at least one rear wheel, and the limiting structure prevents the rear wheel from rotating to a forward position.

5. The wheeled mobile device according to claim 3, wherein:
one of the first limiting part and the second limiting part is a pin movable close to or away from the other one of the first limiting part and the second limiting part;
the other one of the first limiting part and the second limiting part is a groove extending around the directing axis;
the first limiting part is operatively movable and insertable into the second limiting part to limit the rotation range between the first housing and the second housing according to an extension range of the second limiting part.

6. The wheeled mobile device according to claim 5, wherein:
the pin moves in a direction substantially parallel to the directing axis.

7. The wheeled mobile device according to claim 5, wherein:
the second limiting part is provided in the other one of the first housing and the second housing, and at an interface where the first housing and the second housing are adjacent to each other.

8. The wheeled mobile device according to claim 5, wherein:
the second limiting part is further provided with a locking hole, the first limiting part is insertable into the locking hole to prevent the relative rotation between the first housing and the second housing.

9. The wheeled mobile device according to claim 8, wherein:
the locking hole is provided at a middle of a circumferential direction of the second limiting part.

10. The wheeled mobile device according to claim 5, wherein:
the groove has an arc-shape with an extension range of 300°.

11. The wheeled mobile device according to claim 3, wherein:
the first limiting part is connected to an unlocking structure through a connecting member, and the unlocking structure is operable to move the first limiting part away from the second limiting part through the connecting member.

12. The wheeled mobile device according to claim 11, wherein the unlocking structure comprises:
a driving member connected to a first end of the connecting member and rotatable to pull the connecting member;
an operating member operable to move from an outside of the wheeled mobile device; and
a moving member engaged to the operating member, wherein the driving member is driven by the moving member according to the movement of the operating member.

13. The wheeled mobile device according to claim 12, wherein:
a second end of the connecting member is connected to the first limiting part, and the first limiting part is disengaged from the second limiting part by the connecting member according to the pulling of the connecting member.

14. The wheeled mobile device according to claim 12, wherein:
the operating member is provided at a handlebar of the wheeled mobile device and is movable perpendicular to the handlebar;
the operating member is protruded towards an interior of the handlebar to form an abutment which abuts the moving member;
the moving member is formed with a guiding part on a side facing the driving member, and a protrusion part rising along a rotation axis of the driving member is provided on a periphery of the driving member, wherein the guiding part abuts the protrusion part causing the movement of the operating member to drive the moving member, and the guiding part then abuts the protrusion part to rotate the driving member.

15. The wheeled mobile device according to claim 12, wherein:
the unlocking structure includes two driving members, wherein one of the driving members drives the limiting structure through the connecting member, and the other one of the driving members drives a unlocking module through the other connecting member;
the unlocking structure comprises two moving members corresponding to the two driving members and capable of driving the corresponding driving member, respectively;
the operating member is provided to selectively abut one of the two moving members.

16. The wheeled mobile device according to claim 15, wherein:
the unlocking structure further includes a selecting member operable to form a linkage between one of the two moving members and the operating member, such that the moving member in linkage with the operating member is pushable by the operating member, thereby driving the corresponding driving member.

17. The wheeled mobile device according to claim 1, wherein:
the limiting structure is connected to the wheel through a wheel seat movable longitudinally relative to the limiting structure, and a buffer spring is provided between the limiting structure and the wheel seat.

18. (canceled)

19. A wheeled mobile device, wherein the wheeled mobile device comprises:
a frame body;
two wheels provided below the frame body and rotatable around a directing axis relative to the frame body; and
a limiting structure provided between the two wheels that limits a range of directional rotation of the wheels.

20. The wheeled mobile device according to claim 19, wherein the limiting structure comprises:
two first housings connected to the frame body, respectively;
two second housings connected to the two wheels and rotatable around the directing axis relative to the two first housings, respectively; and
a linkage member connected to the two second housings, such that the two second housings rotate synchronously around their respective directional axes.

21. The wheeled mobile device according to claim 20, wherein:
the linkage member is a rod that extends transversely and connected to each second housing through a respective linkage shaft parallel to the directing axis; and
the linkage member interferes with the first housing to limit the rotational range of the second housings.
